(19) United States
(12) Patent Application Publication
(10) Pub. No.: US 2016/0233761 A1
(43) Pub. Date: Aug. 11, 2016

(54) Systems and Methods for Providing a Transformerless Power Supply

(71) Applicant: Smart Fos, Inc., Sunnyvale, CA (US)

(72) Inventors: Neil Joseph, Sunnyvale, CA (US); Francis Joseph, Sunnyvale, CA (US)

(21) Appl. No.: 15/014,723

(22) Filed: Feb. 3, 2016

Related U.S. Application Data
(60) Provisional application No. 62/113,576, filed on Feb. 9, 2015.

(51) Int. Cl. H02M 3/04; H05B 33/08; H02M 7/02

(52) U.S. Cl. CPC H02M 3/04; H02M 7/02; H05B 33/0815

(57) ABSTRACT

Systems and methods are provided for a transformerless power supply. A first capacitor is positioned between an input node and an intermediate node. A second capacitor is positioned between an output node and a ground node. A first switch is positioned between the intermediate node and the output node, a second switch is positioned between the intermediate node and the ground node, and a third switch is positioned between the input node and the output node. A controller is configured to control the first switch, the second switch, and the third switch to provide output power within a prespecified range.

### CROSS-REFERENCE TO RELATED APPLICATIONS

This application claims priority to U.S. Provisional Application No. 62/113,576, filed Feb. 9, 2015, entitled “Systems and Methods for Providing a Transformerless Power Supply,” the entirety of which is herein incorporated by reference.

### FIELD

The technology described in this patent document relates generally to power supplies and more specifically to power supplies for lighting with reduced to eliminated transformer counts.

### BACKGROUND

There are a wide variety of power supplies that are readily available for use in applications such as for providing power to lighting systems (e.g., lighting systems that provide LED light). Such power supplies often include components such as step-up or step-down transformers, DC-to-DC converters, AC-to-DC converters, buck and/or boost converters, and flybacks. In such power supplies, transformers tend to play a key role in providing the desired power supply voltage. But, the transformer is one of the single cost components of such power supplies. Systems and methods as described herein seek to reduce the number of transformers present in power supplies to reduce size and cost.

### SUMMARY

Systems and methods are provided for a transformerless power supply. A first capacitor is positioned between an input node and an intermediate node. A second capacitor is positioned between an output node and a ground node. A first switch is positioned between the intermediate node and the output node, a second switch is positioned between the intermediate node and the ground node, and a third switch is positioned between the input node and the output node. A controller is configured to control the first switch, the second switch, and the third switch to provide output power within a prespecified range.

As another example, a method of providing power includes controlling a set of three switches based on an input voltage and a threshold voltage, a first switch being positioned between an intermediate node and an output node, a second switch being positioned between the intermediate node and a ground node, and a third switch being positioned between an input node and the output node, where a first capacitor is positioned between the input node and the intermediate node and a second capacitor is positioned between the output node and a ground node. The set of three switches is controlled by opening the first switch and closing the second switch and the third switch when the input voltage is less than the threshold voltage, and closing the first switch and opening the second switch and the third switch when the input voltage is greater than the threshold voltage.

### BRIEF DESCRIPTION OF THE DRAWINGS

FIG. 1 is a block diagram depicting a schematic for a transformerless power supply.

FIG. 2 is a diagram depicting an example DC power source voltage generated from a rectified voltage.

FIG. 3 is a block diagram depicting a voltage crossing detector configured to control the switches SW1, SW2, SW3 of FIG. 1.

FIG. 4 depicts a truth table indicating the states commanded of the switches by the voltage crossing detector based on the relation of the input signal voltage to the threshold voltage.

FIG. 5 is a flow diagram depicting a method of providing power.

### DETAILED DESCRIPTION

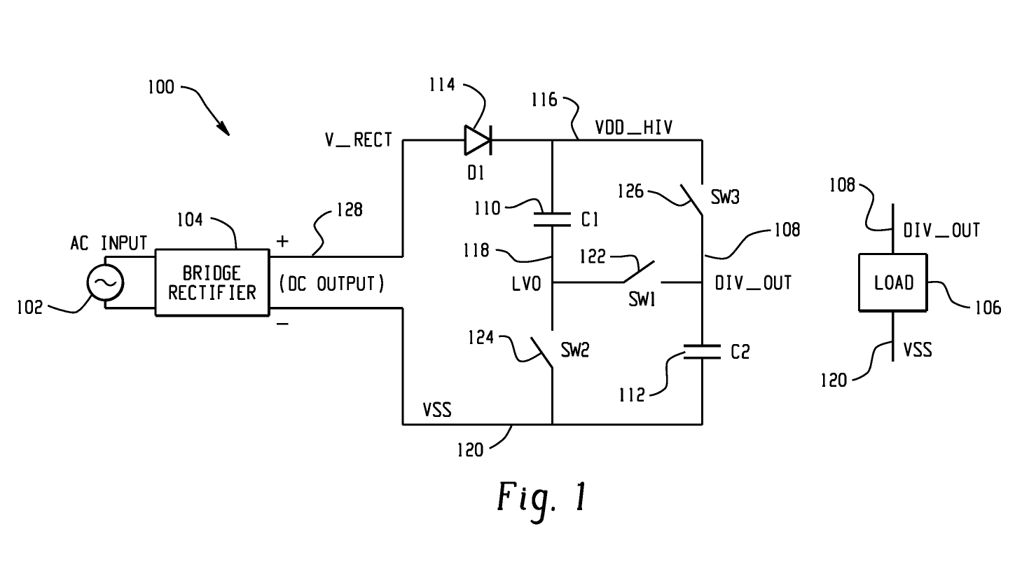

FIG. 1 is a block diagram depicting a schematic for a transformerless power supply for use in an application such as providing lights via LED light bulbs. The power supply 100 includes an AC input 102 (e.g., a 120 Vᵣₘₛ or 240 Vᵣₘₛ voltage at a light socket) rectified by bridge rectifier 104 to generate a DC voltage (e.g., a 170V or 339V DC voltage). A load 106 is configured to use a lower DC voltage than is provided by the bridge rectifier 104. In one embodiment, the load 106 is an LED light source that utilizes a 38V DC voltage.

In the example of FIG. 1, a circuit that includes a plurality of capacitors is utilized to generate the necessary voltage for the load 106 at node 108. A capacitive divider is formed by a first capacitor C1 110 and a second capacitor C2 112. A diode 114 isolates an input node 116 of the capacitive circuit from the bridge rectifier 104. The first capacitor 110 is positioned between the input node 116 and an intermediate node 118. The second capacitor is positioned between the output node 108 and a ground node 120. The capacitive circuit includes a plurality of switches. A first switch SW1 122 is positioned between the intermediate node 118 and the output node 108. A second switch SW2 124 is positioned between the intermediate node 118 and the ground node 120. A third switch SW3 126 is positioned between the input node 116 and the output node 108. By controlling the three switches 122, 124, 126, the power supply 100 of FIG. 1 provides DC power within a desired range (e.g., ˜38V DC) to operate the load 106.

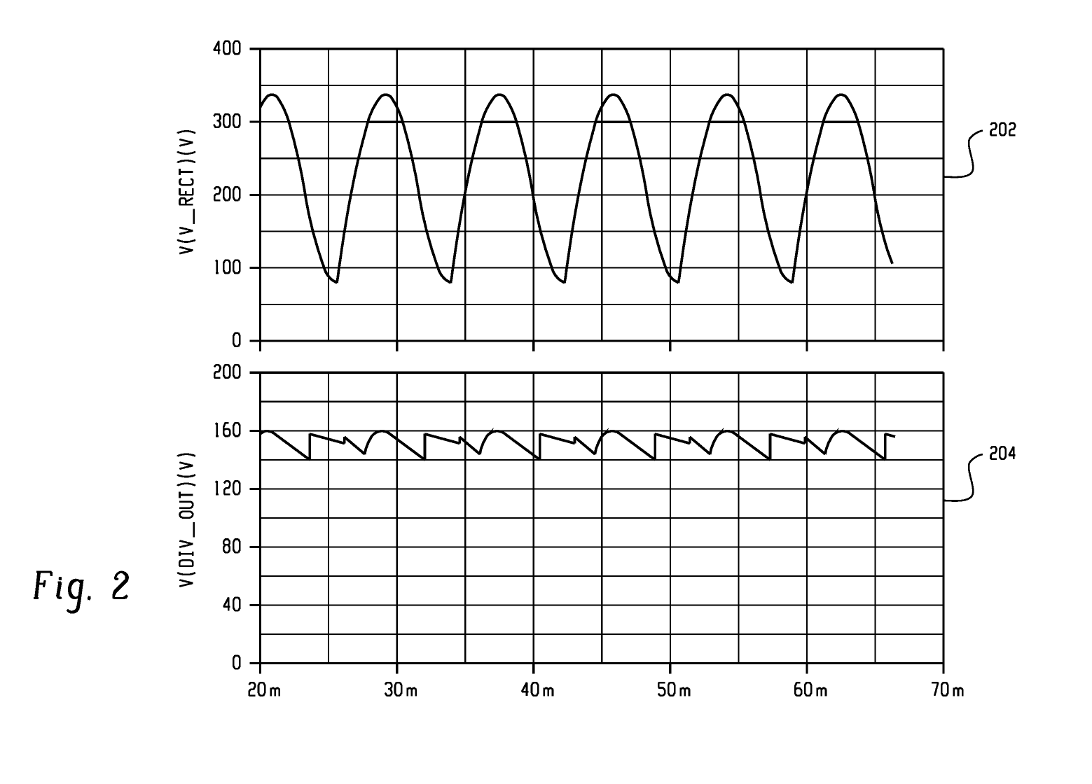

FIG. 2 is a diagram depicting an example DC power source voltage generated from a rectified voltage. A rectified voltage measurement, taken at the output of the bridge rectifier 104 in FIG. 1 at 128 indicates the voltage that is provided to the input node 116 via the isolating diode 114. Using that input voltage signal 202, the capacitive divider circuit provides the output signal depicted at 204 at output node 108. That DC voltage provided at 108 can be utilized to power a load, such as load 106. While the voltage indicated at 204 varies slightly around an average voltage level, it is sufficiently stable for many loads 106. Additional circuitry can be incorporated into the capacitive circuit of FIG. 1 to lessen the variation and provide a more stable DC output voltage.

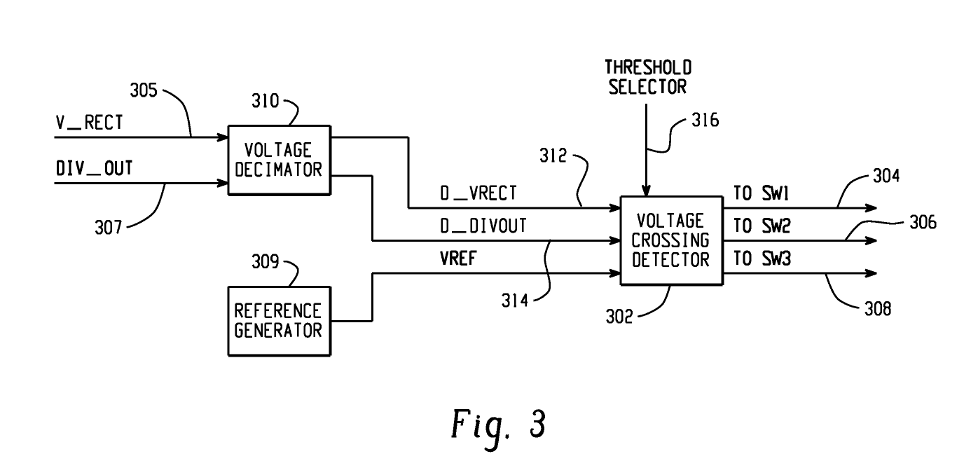

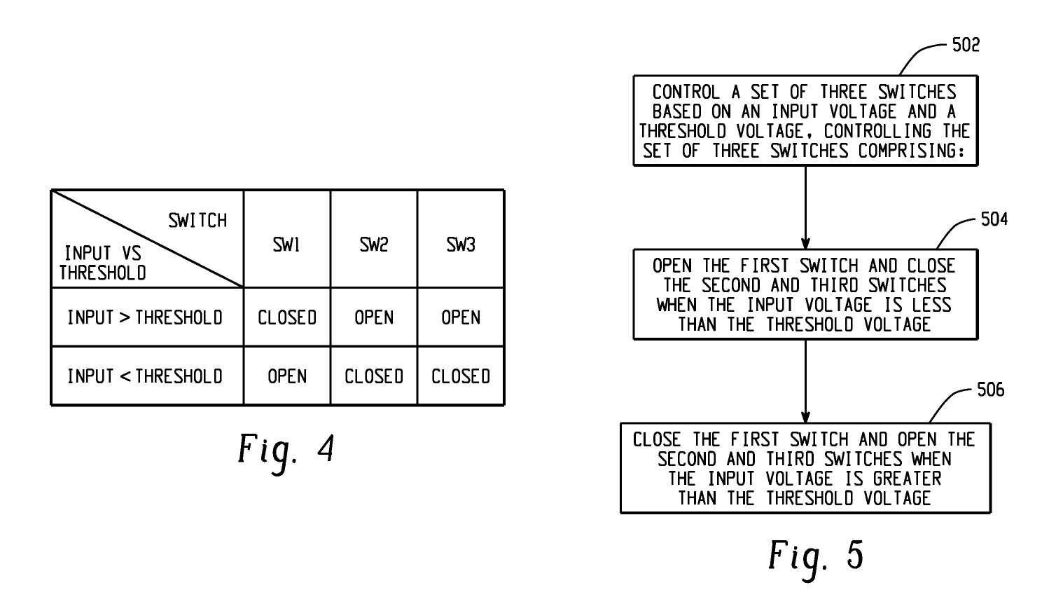

The switches SW1, SW2, SW3 can be operated via a variety of mechanisms to generate the output voltage depicted in FIG. 2 at 204. FIG. 3 is a block diagram depicting a voltage crossing detector configured to control the switches SW1, SW2, SW3 of FIG. 1. The voltage crossing detector 302 generates output signals 304, 306, 308 to switches SW1, SW2, SW3, respectively based on two input signals. A first input to the voltage crossing detector 302 is based on an input voltage (e.g., from 116 or 128 of FIG. 1) to the capacitive circuit. A second input is a threshold input (e.g., a threshold voltage based on the output voltage at 108 or a user selected threshold voltage). As the time-varying input voltage (e.g., as depicted in FIG. 2 at 202) crosses the threshold voltage to a voltage higher than the threshold voltage, the voltage crossing detector 302 is configured to: close the first switch SW1 122 such that the intermediate node 118 is connected to the output node 108; open the second switch SW2 124 such that the intermediate node 118 is disconnected from the ground node 120; and open the third switch SW3 126 such that the input node 116 is disconnected from the output node 108. As the time-varying input voltage then crosses the threshold voltage to a voltage lower than the threshold voltage, the voltage crossing detector 302 is configured to: open the first switch SW1 122 such that the intermediate node 118 is disconnected from the output node 108; close the second switch SW2 124 such that the intermediate node 118 is connected to the ground node 120; and close the third switch SW3 126 such that the input node 116 is connected to the output node 108. FIG. 4 depicts a truth table indicating the states commanded of the switches 122, 124, 126 by the voltage crossing detector 302 based on the relation of the input signal voltage to the threshold voltage.

The example of FIG. 3 depicts an example switch control circuit that receives the first input based on the input voltage 128 to the capacitive circuit, received at 305, and two user-selectable options for threshold voltages. A first potential threshold voltage is based on the voltage at the output node 108 that is received at 307, and a second potential threshold voltage is provided by a reference generator 309, such as based on a user-selectable parameter. A voltage decimator 310 proportionally reduces the input signals received at 305, 307 to produce corresponding inputs 312, 314 to the voltage crossing detector 302 that are within an acceptable operating range of the detector. A threshold selector input 316 to the voltage crossing detector 302 enables user selection of either the output node voltage 307 or the reference generator 309 voltage as the basis for the voltage crossing detector threshold 302. As discussed in detail above, the voltage crossing detector 302 provides control signals 304, 306, 308 to switches SW1, SW2, SW3, respectively based on the directions of crossings of the input signal 312 with respect to the selected threshold signal 309 or 314.

In one example, with reference to FIG. 1, V_rect 128 is an unfiltered rectified voltage, as depicted in FIG. 2 at 202. When V_rect 128 is at its peak value, C1 110 and C2 112 are connected in series, and the output voltage div_out 108 is based on the ratio of the values of capacitors C1 110 and C2 112. This is accomplished by closing switch SW1 122 and opening switches SW2 124 and SW3 126. As V_rect 128 falls below the threshold value (e.g., based on div_out 108), capacitor C1 110 is disconnected from capacitor C2 112 by opening switch SW1 122. The intermediate node 128 is connected to the ground node 120 by closing switch SW2 124. The output terminal div_out 108, which is the high voltage terminal of capacitor C2 112 is connected to the input node VDD_hiV 116 by closing switch SW3 126. Because the high voltage input of capacitor C1 110 is also connected to the input node VDD_hiV 116, C1 110 and C2 112 are then in a parallel configuration. The charge stored on C1 110 is thus shared by C2 112. This configuration helps maintain the output voltage div_out 108 at the required level while V_rect 128 is less than the threshold voltage (e.g., div_out 108). As time elapses, the value of V_rect 128 increases until it surpasses the threshold voltage (e.g., div_out 108). At that point, C1 110 and C2 112 are returned to a series configuration by closing switch SW1 122 and opening switches SW2 124 and SW3 126.

FIG. 5 is a flow diagram depicting a method of providing power, such as to a smart lighting system where LED light bulbs are networked and configured to monitor light levels and adjust accordingly to provide a user-specified level of light. A set of three switches are controlled at 502 based on an input voltage and a threshold voltage, a first switch being positioned between an intermediate node and an output node, a second switch being positioned between the intermediate node and a ground node, and a third switch being positioned between an input node and the output node, where a first capacitor is positioned between the input node and the intermediate node and a second capacitor is positioned between the output node and a ground node. The set of three switches is controlled by opening the first switch and closing the second switch and the third switch at 504 when the input voltage is less than the threshold voltage, and closing the first switch and opening the second switch and the third switch at 506 when the input voltage is greater than the threshold voltage.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents. For example, power supplies as described herein can be configured to power smart lighting applications, such as those described in U.S. patent application Ser. No. 14/288,911, entitled “Systems and Methods for Providing a Self-Adjusting Light Source,” the entirety of which is herein incorporated by reference.

It is claimed:

1. A transformerless power supply, comprising:
a first capacitor positioned between an input node and an intermediate node;
a second capacitor positioned between an output node and a ground node;
a first switch positioned between the intermediate node and the output node;
a second switch positioned between the intermediate node and the ground node;
a third switch positioned between the input node and the output node; and
a controller configured to control the first switch, the second switch, and the third switch to provide output power within a prespecified range.

2. The power supply of claim 1, wherein the output power is near-DC output power that varies only within the pre-specified range.

3. The power supply of claim 1, wherein the controller is configured to open the first switch when an input voltage falls below a threshold voltage.

4. The power supply of claim 3, wherein opening the first switch disconnects the intermediate node from output node.

5. The power supply of claim 3, wherein the controller is further configured to close the second switch when the input voltage falls below the threshold voltage.

6. The power supply of claim 5, wherein the controller is further configured to close the third switch when the input voltage falls below the threshold voltage.

7. The power supply of claim 6, wherein closing the second switch and closing the third switch connects the intermediate node to the ground node and connects the input node to the output node.

8. The power supply of claim 6, wherein the controller is further configured to close the first switch, open the first switch, and open the second switch when the input voltage rises above the threshold voltage.

9. The power supply of claim 3, wherein the threshold voltage is a voltage at the output mode.

10. The power supply of claim 3, wherein the threshold voltage is a prespecified threshold voltage.

11. The power supply of claim 3, wherein the controller comprises a voltage crossing detector that provides switching inputs to the first switch, the second switch, and the third switch based on the input voltage and the threshold voltage.

12. The power supply of claim 11, wherein the input voltage is based on a pre-decimation input voltage following traversal of a voltage decimator.

13. The power supply of claim 11, wherein the voltage crossing detector is configured to change the switching inputs as the input voltage crosses the threshold voltage.

14. The power supply of claim 1, further comprising a rectifier circuit configured to provide a rectified voltage to the input node.

15. The power supply of claim 14, further comprising a diode positioned between the rectifier circuit and the input node.

16. The power supply of claim 1, further comprising a light configured to receive power via the output node.

17. The power supply of claim 1, wherein the light is an LED light.

18. The power supply of claim 1, wherein the first capacitor and the second capacitor are sized to provide power near the center of the prespecified range based on a magnitude of an input voltage.

19. A method of providing power, comprising:
controlling a set of three switches based on an input voltage and a threshold voltage, a first switch being positioned between an intermediate node and an output node, a second switch being positioned between the intermediate node and a ground node, a third switch being positioned between an input node and the output node, wherein a first capacitor is positioned between the input node and the intermediate node and a second capacitor is positioned between the output node and a ground node;
controlling the set of three switches comprising:
opening the first switch and closing the second switch and the third switch when the input voltage is less than the threshold voltage; and
closing the first switch and opening the second switch and the third switch when the input voltage is greater than the threshold voltage.
